(19) United States
(12) Patent Application Publication
(10) Pub. No.: US 2023/0376604 A1
(43) Pub. Date: Nov. 23, 2023

(54) DETERMINATION OF MITIGATION PRIORITY VALUES OF VULNERABILITIES IN CONTAINER IMAGES

(71) Applicant: Microsoft Technology Licensing, LLC, Redmond, WA (US)

(72) Inventors: Josef WEIZMAN, Haifa (IL); Aharon MICHAELS, Beit Shemesh (IL); Lior KESTEN, Jerusalem (IL); Assaf ISRAEL, Ganey-Tikva (IL)

(73) Assignee: Microsoft Technology Licensing, LLC, Redmond, WA (US)

(21) Appl. No.: 17/748,819

(22) Filed: May 19, 2022

(51) Int. Cl. G06F 21/57

(52) U.S. Cl. CPC G06F 21/577; G06F 2221/033

(57) ABSTRACT

According to examples, an apparatus may include a processor and a memory on which is stored machine-readable instructions that may cause the processor to access vulnerabilities identified in a set of container images and to identify, from a set of reference vulnerabilities, which reference vulnerabilities the identified vulnerabilities match, in which each of the reference vulnerabilities is assigned one of a plurality of mitigation priority values. The processor may also determine mitigation priority values of the identified vulnerabilities based on the mitigation priority values assigned to the reference vulnerabilities to which the identified vulnerabilities match. In addition, the processor may output the determined mitigation priority values of the identified vulnerabilities.

### BACKGROUND

A container image may be defined as a lightweight, standalone, executable package of software that may include code, metadata, runtime, system tools, system libraries, and settings needed to run an application, e.g., in a software container. In many instances, container images are unchangeable, static files that include executable code such that the container images may be run as an isolated process on an infrastructure. Container images become containers (or software containers) at runtime and may be the same regardless of the underlying infrastructure upon which the containers are executed. In addition, unlike virtual machines, containers do not require or include a separate operating system. Instead, containers rely on the functionality of kernels and use hardware resources (CPU, memory, I/O, network, etc.) and separate namespaces to isolate the applications' views of the operating systems.

### BRIEF DESCRIPTION OF DRAWINGS

Features of the present disclosure are illustrated by way of example and not limited in the following figure(s), in which like numerals indicate like elements, in which:

FIG. 1 shows a block diagram of a network environment, in which an apparatus may determine mitigation priority values of identified vulnerabilities in container images, in accordance with an embodiment of the present disclosure;

FIGS. 2 and 3, respectively, depict block diagrams of the apparatus depicted in FIG. 1, in accordance with embodiments of the present disclosure;

FIG. 4 depicts a flow diagram of a method for assigning mitigation priority values to a plurality of vulnerabilities identified in a set of container images and outputting the assigned mitigation priority values, in accordance with an embodiment of the present disclosure;

FIG. 5 depicts a flow diagram of a method for assigning mitigation priority values to reference vulnerabilities, in accordance with an embodiment of the present disclosure; and

FIG. 6 shows a block diagram of a computer-readable medium that may have stored thereon computer-readable instructions for assigning respective mitigation priority values to identified vulnerabilities in a set of container images based on mitigation priority values of reference vulnerabilities, in accordance with an embodiment of the present disclosure.

### DETAILED DESCRIPTION

For simplicity and illustrative purposes, the principles of the present disclosure are described by referring mainly to embodiments and examples thereof. In the following description, numerous specific details are set forth in order to provide an understanding of the embodiments and examples. It will be apparent, however, to one of ordinary skill in the art, that the embodiments and examples may be practiced without limitation to these specific details. In some instances, well known methods and/or structures have not been described in detail so as not to unnecessarily obscure the description of the embodiments and examples. Furthermore, the embodiments and examples may be used together in various combinations.

Throughout the present disclosure, the terms “a” and “an” are intended to denote at least one of a particular element. As used herein, the term “includes” means includes but not limited to, the term “including” means including but not limited to. The term “based on” means based at least in part on.

Containers (e.g., software containers) are rapidly becoming a mainstream technology due to, for instance, the ease with which the containers may be integrated with cloud-computing platforms as well as the flexibility the containers afford. The container images may, in some instances, include vulnerabilities, which may be defined as security risks that are embedded within container images, bad practices, and/or the like. These vulnerabilities may not themselves pose threats, but containers created based on the container images with the vulnerabilities may introduce threats to live environments. The vulnerabilities may arise from certain code, e.g., malicious code, being written or inserted into the container images. The vulnerabilities may also or alternatively arise from insecure libraries or other dependencies that may be imported into the container images. The container image vulnerabilities may be detected through execution of container image scanning tools or processes, which may scan for and detect known vulnerabilities in the container images.

Once a vulnerability has been detected in a container image, a remediation process may be implemented to mitigate or remove the vulnerability. An owner or other entity responsible for the container image may implement the remediation process by taking some actions to remove the vulnerability or otherwise cause the vulnerability to become innocuous. For instance, an updated version of the container image that does not include the vulnerability may be stored in a registry. As another example, a patch that removes the vulnerability may be applied on the container image to remove the vulnerability. The update or the patch to the container image may result in a new version of the container image being stored in a registry. The process of updating and/or patching container images may consume a considerable amount of time and effort. In addition, during execution of the remediation process, the container image may be offline and may thus be unavailable for use, which may disrupt operations of an organization that may utilize the container image.

In many instances, organizations may own and/or utilize relatively large numbers of container images that may be stored in one or more registries. The number of container images may be even greater, for instance, in the thousands or tens of thousands of container images because the container images may be built in multiple layers. Execution of container image scanning processes on such large numbers of container images may often result in the detection of a significant number of vulnerabilities in the container images. For instance, tens, hundreds, or thousands of vulnerabilities may be detected in the container images of an organization and multiple vulnerabilities may be detected in individual container images.

Oftentimes, organizations may seek to remediate or mitigate vulnerabilities as soon as the vulnerabilities are detected regardless of the impacts the vulnerabilities may have on the security of the organizations. In other instances, organizations may seek to remediate or mitigate vulnerabilities according to some perceived importance levels of the vulnerabilities, e.g., based on potential level of harm caused by when the vulnerabilities are exploited. For instance, organizations may prioritize the mitigation of vulnerabilities that have the potential for the greatest levels of harm, e.g., pose the greatest threats if exploited, over the mitigation of other vulnerabilities. However, some of the vulnerabilities may be such that they are not readily exploited, they are difficult to exploit, may be in container images that are not often used, and/or the like. As a result, even though the vulnerabilities may result in relatively high levels of issues when they are exploited, they may not be readily accessible or frequently used. In contrast, some vulnerabilities that may result in relatively lower levels of issues when they are exploited may be readily accessible and/or frequently used. Accordingly, mitigating the vulnerabilities based on the order in which the vulnerabilities are detected or based on the levels of threats posed by the vulnerabilities may result in the vulnerabilities being mitigated according to an inefficient prioritization order. That is, relatively innocuous vulnerabilities may be remediated prior to readily exploitable vulnerabilities and/or the relatively harmful vulnerabilities remaining exploitable for relatively long periods of time.

A technical issue with known processes for prioritizing the mitigation of vulnerabilities in container images may thus be that the vulnerabilities that may have greater susceptibilities to cause harm, e.g., pose security threats, may not be mitigated prior to other vulnerabilities that may have lower susceptibilities to cause harm. In contrast, disclosed herein are apparatuses, methods, and computer-readable media that may enable the mitigation of the vulnerabilities to be prioritized according to how personnel who previously encountered the vulnerabilities prioritized the vulnerabilities. Particularly, the lengths of time between when the vulnerabilities were identified and when the vulnerabilities were mitigated may be determined. As personnel, such as members of organizations, may mitigate the vulnerabilities that they perceive as posing the greatest threats, e.g., having the greatest potential for exploitation, posing the greatest security threats, posing the greatest potential for waste, and/or the like, the determined lengths of time may provide an indication as to the priority levels at which the vulnerabilities should be mitigated.

As discussed herein, mitigation priority values may be assigned to a plurality of reference vulnerabilities, in which the mitigation priority values may correspond to the lengths of time between when the reference vulnerabilities were identified and when they were mitigated. In instances in which there are a number of such lengths of time for a reference vulnerability and thus, multiple mitigation priority values assigned to the reference vulnerability, an average mitigation priority value may be determined from the multiple mitigation priority values and assigned to the reference vulnerability. The reference vulnerabilities and the mitigation priority values assigned to the reference vulnerabilities may be determined over a period of time and may be stored in a database.

According to examples, a processor may identify which of the reference vulnerabilities that vulnerabilities identified in a set of container images match. The processor may assign the mitigation priority values of the reference vulnerabilities to which the vulnerabilities match to the identified vulnerabilities in the set of container images. In addition, the processor may output the mitigation priority values assigned to the identified vulnerabilities in the set of container images. For instance, the processor may output the mitigation priority values to a member of an organization that owns or manages the set of container images. The member may mitigate the vulnerabilities in the set of container images according to the mitigation priority values assigned to the vulnerabilities to optimize the order in which the vulnerabilities are mitigated.

Through implementation of the features of the present disclosure, a processor may determine the priority order in which vulnerabilities in a set of container images should be mitigated. The priority order may cause a reduction or minimization in the lengths of time that vulnerabilities determined by personnel as posing the greatest level of threats, e.g., being relatively easily exploitable, posing a high level of harm, etc., are exploitable. As a result, implementation of the features of the present disclosure may enable a processor to determine a prioritization order at which vulnerabilities in container images are to be mitigated that may improve security in the usage of container images. In other words, a technical improvement afforded through implementation of features of the present disclosure may be that the processor may reduce or minimize the exploitation of vulnerabilities in container images by determining an optimized prioritization order at which vulnerabilities in the container images are to be mitigated.

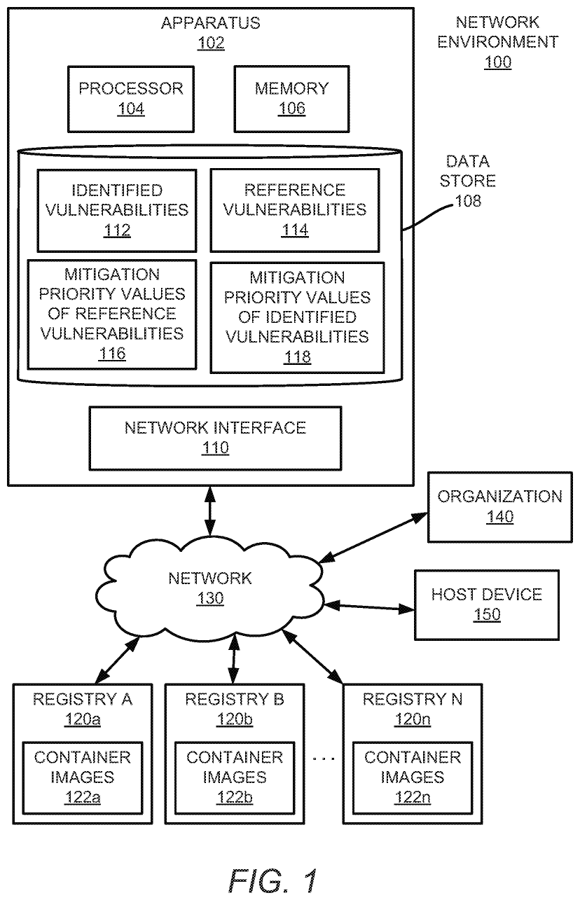

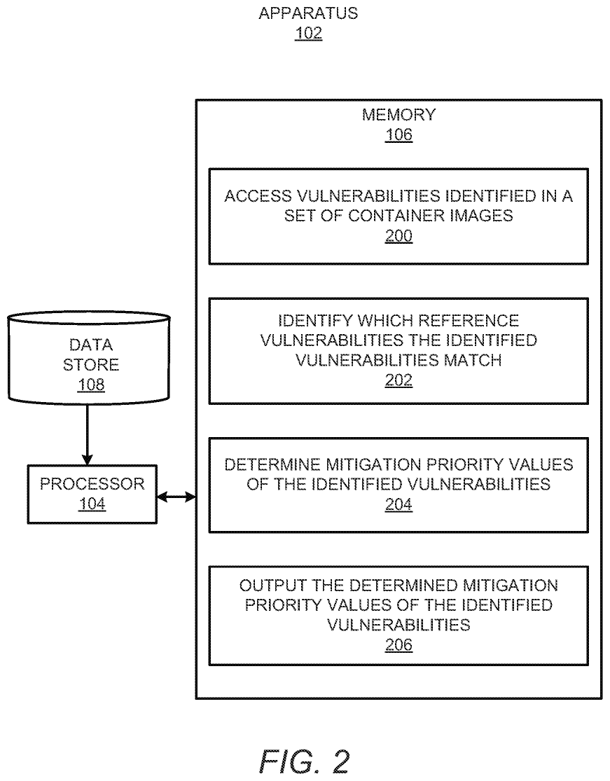

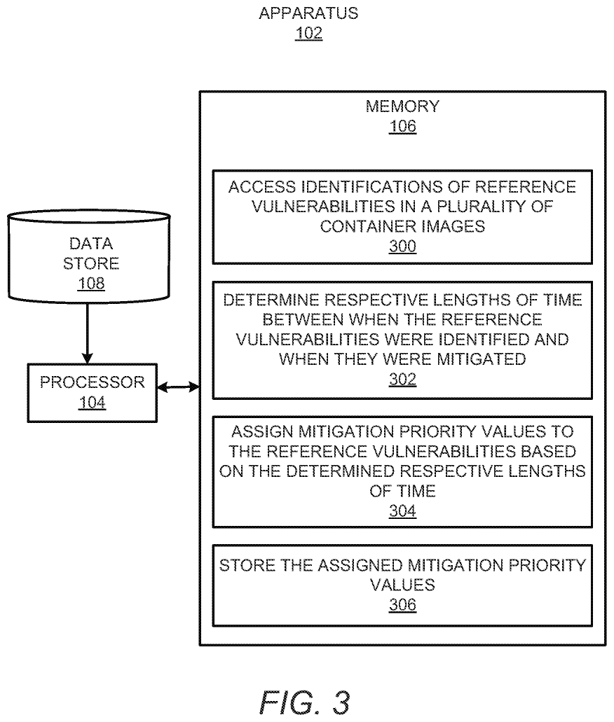

Reference is first made to FIGS. 1-3. FIG. 1 shows a block diagram of a network environment 100, in which an apparatus 102 may determine mitigation priority values 118 of identified vulnerabilities 112 in container images 122a-122n, in accordance with an embodiment of the present disclosure. FIGS. 2 and 3, respectively, depict block diagrams of the apparatus 102 depicted in FIG. 1, in accordance with embodiments of the present disclosure. It should be understood that the network environment 100 and/or the apparatus 102 may include additional features and that some of the features described herein may be removed and/or modified without departing from the scopes of the network environment 100 and/or the apparatus 102.

As shown in FIG. 1, the network environment 100 may include the apparatus 102, a plurality of registries 120a-120n (in which the variable “n” may denote a value greater than one), a network 130, an organization 140, and a host device 150. The apparatus 102 may be a computing device such as a server, a laptop computer, a desktop computer, a tablet computer, and/or the like. In particular examples, the apparatus 102 is a server on the cloud. In some examples, functionalities of the apparatus 102 may be spread over multiple apparatuses 102, multiple virtual machines, and/or the like. The apparatus 102 may include a network interface 110 through which the apparatus 102 may communicate with components over the network 130. The network 130 may be an internal network, such as a local area network, an external network, such as the Internet, or a combination thereof.

As shown in FIGS. 1 and 2, the apparatus 102 may include a processor 104 that may control operations of the apparatus 102. Thus, for instance, references made herein to the apparatus 102 performing various operations should equivalently be construed as meaning that the processor 104 of the apparatus 102 may perform those various operations. The apparatus 102 may also include a memory 106 on which instructions that the processor 104 may access and/or may execute may be stored. In addition, the processor 104 may include a data store 108 on which the processor 104 may store and access various information as discussed herein. The processor 104 may be a semiconductor-based microprocessor, a central processing unit (CPU), an application specific integrated circuit (ASIC), a field-programmable gate array (FPGA), and/or other hardware device.

The memory 106 and the data store 108, which may also each be termed a computer readable medium, may each be, for example, a Random Access memory (RAM), an Electrically Erasable Programmable Read-Only Memory (EEPROM), a storage device, or the like. The memory 106 and/or the data store 108 may be a non-transitory computer readable storage medium, where the term “non-transitory” does not encompass transitory propagating signals. In any regard, the memory 106 may have stored thereon machine-readable instructions that the processor 104 may execute. The data store 108 may have stored thereon data that the processor 104 may enter or otherwise access.

Although the apparatus 102 is depicted as having a single processor 104, it should be understood that the apparatus 102 may include additional processors and/or cores without departing from a scope of the apparatus 102. In this regard, references to a single processor 104 as well as to a single memory 106 may be understood to additionally or alternatively pertain to multiple processors 104 and/or multiple memories 106. In addition, or alternatively, the processor 104 and the memory 106 may be integrated into a single component, e.g., an integrated circuit on which both the processor 104 and the memory 106 may be provided. In addition, or alternatively, the operations described herein as being performed by the processor 104 may be distributed across multiple apparatuses 102 and/or multiple processors 104.

According to examples, the apparatus 102 may be in communication with the registries 120a-120n, which may also be termed image registries 120a-120n, via the network 130. Each of the registries 120a-120n may store respective sets of container images 122a-122n. Thus, a first registry 120a may store a first set of container images 122a, a second registry 120b may store a second set of container images 122b, etc. Generally speaking, each of the registries 120a-120n may be a data repository that allows programming and testing of container images 122a-122n. In addition, the registries 120a-120n may provide a centralized resource for discovery, management, distribution, collaboration, etc., of base container images. The registries 120a-120n may be hardware devices and/or software stored in hardware devices, such as data storage devices.

In some examples, various organizations may own and manage respective ones of the registries 120a-120n. For instance, a first organization 140 may manage a first registry 120a, a second organization may manage a second registry 120b, and so forth. For instance, members of the organizations may store the container images 122a-122n into respective ones of the registries 120a-120n. The members may also update the container images 122a-122n by applying patches to the container images 122a-122n, replacing the container images 122a-122n with newer versions of the container images 122a-122n, etc. The members may further remove older versions of the container images 122a-122n and/or unused container images 122a-122n. In some instances, the members of different organizations may store the same container images 122a in multiple registries 120a, 120b.

The container images 122a-122n may become containers during runtime. That is, the container images 122a-122n may be uploaded to the host device 150 from the registries 120a-120n and the host device 150 may run the container images 122a-122n. The host device 150 may be a physical machine, a virtual machine, a cloud infrastructure, and/or the like. The host device 150 may also be deployed in a data center, a cloud computing platform (e.g., a public cloud platform, a private cloud platform, or a hybrid cloud platform), on-premises, or in a combination thereof. Although a single host device 150 is depicted in FIG. 1, it should be understood that the container images 122a-122n may be uploaded to a plurality of host devices in the computing environment 100.

In some situations, some of the container images 122a-122n may include vulnerabilities, which may be security or other risks that may be embedded within container images. The other risks may be operations that may be linked to bad practices, e.g., inefficient operations, operations that may result in security vulnerabilities, etc. The vulnerabilities may arise from certain code, e.g., malicious code, being written or inserted into the container images. The vulnerabilities may also or alternatively arise from insecure libraries or other dependencies that may be imported into the container images. In some instances, the vulnerabilities may be exploited for malicious purposes. By way of example, the vulnerabilities may be exploited to cause the containers created based on the container images 122a-122n to perform malicious actions such as, spreading computer viruses, spyware, ransomware, worms, adware, Trojan horses, distributed denial of service (DDoS) attacks, and/or the like.

In some examples, the members of the organizations and/or the apparatus 102 may execute container image scanning processes to detect the vulnerabilities in the container images 122a-122n. The container image scanning processes may analyze the container images 122a-122n to determine whether the container images 122a-122n include any known vulnerabilities. For instance, the container image scanning processes may access databases or libraries of known vulnerabilities and may scan the container images 122a-122n for the known vulnerabilities. As new vulnerabilities may continue to be identified, the databases or libraries may continue to be updated with newly identified vulnerabilities. In addition, the container image scanning processes may be performed on the container images 122a-122n over time to determine whether the container images 122a-122n include newly identified vulnerabilities and/or have been modified to include other vulnerabilities.

When vulnerabilities are detected, the members of the organizations may implement a remediation process to remove or make the vulnerability potentially less problematic. For instance, the members may apply an update or a patch on the container images 122a-122n, in which the update or patch may fix the vulnerability. As discussed herein, the remediation processes may take a considerable amount of time and effort and thus, when there are a large number of vulnerabilities, some vulnerabilities that may cause lesser levels of problems may be resolved prior to vulnerabilities that may cause greater levels of problems. In many instances, the vulnerabilities may be remediated in an ad hoc manner or in an order in which the vulnerabilities are detected. This may cause the more potentially problematic vulnerabilities to be exploitable for relatively long periods of time, which may make the organizations more susceptible to greater threat levels.

In other instances, the vulnerabilities may be remediated according to some perceived importance levels of the vulnerabilities, e.g., based on potential level of harm caused by when the vulnerabilities are exploited. However, in some situations, the vulnerabilities may be such that they are not readily exploited, may be in container images that are not often used, and/or the like. As a result, even though the vulnerabilities may result in relatively high levels of issues when they are exploited, they may not be readily accessible or frequently used. In contrast, some vulnerabilities that may result in relatively lower levels of issues when they are exploited may be readily accessible and/or frequently used. Accordingly, it may be beneficial in some instances to remediate the vulnerabilities associated with the lower levels of importance prior to the vulnerabilities associated with the higher levels of importance.

According to examples discussed herein, the processor 104 may perform operations to determine mitigation priority values for identified vulnerabilities in container images 122a-122n. The mitigation priority values may define the priority levels, e.g., the order, in which the identified vulnerabilities are suggested to be mitigated. As also discussed herein, the mitigation priority values for the identified vulnerabilities may be based on mitigation priority values assigned to reference vulnerabilities. The mitigation priority values assigned to the reference vulnerabilities may correspond to lengths of time between when the reference vulnerabilities were identified and when the reference vulnerabilities were mitigated. In one regard, the order in which the vulnerabilities should be mitigated (or remediated) may be based on the importance levels afforded to them by others as indicated by the urgency placed on their mitigations instead of, for instance, the potential threat levels posed by the vulnerabilities.

As shown in FIG. 2, the memory 106 may have stored thereon machine-readable instructions 200-206 that the processor 104 may execute. The processor 104 may execute the instructions 200 to access vulnerabilities 112 identified in a set of container images 122a. The set of container images 122a may be container images 122a owned and/or managed by a particular organization 140. In some instances, the set of container images 122a may be stored in a single registry 120a, while in other instances, the set of container images 122a may be stored in multiple registries 120a, 120b.

In some examples, the organization 140, or a member of the organization 140 such as IT personnel, administrator, or the like, may identify the vulnerabilities 112 in the set of container images 122a. For instance, a member of the organization 140 may run a container image scanning tool on the set of container images 122a, in which the container image scanning tool may identify vulnerabilities 112 in the set of container images 122a. The container image scanning tool may also determine identifiers of the identified vulnerabilities 112. The identifiers of the vulnerabilities 112 may be letters, numerals, symbols, combinations thereof, etc., that may be used to distinguish the vulnerabilities 112 from each other. In some examples, the container image scanning tool may access a table that includes various properties of known vulnerabilities and the identifiers assigned to the vulnerabilities. The identifiers may have been assigned to the vulnerabilities and may follow a standardized protocol.

In examples in which the member of the organization 140 identified the vulnerabilities 112, the identifiers of the vulnerabilities 112 may be sent to the apparatus 102. For instance, the container image scanning tool may be programmed or otherwise set to upload the identifiers of the vulnerabilities 112 to the apparatus 102. As another example, the member or other personnel in the organization 140 may send the identifiers of the vulnerabilities 112 to the apparatus 102. For instance, the identifiers of the vulnerabilities 112 may be sent through a web portal, a cloud-based folder, and/or the like, that the processor 104 may access. As other examples, the identifiers of the vulnerabilities 112 may be communicated through another communication channel, such as email or other messaging application. In any of these examples, the processor 104 may store the identified vulnerabilities 112 (or the identifiers of the vulnerabilities 112) in the data store 108.

In addition or in other examples, the processor 104 of the apparatus 102 may run the container image scanning tool to identify the vulnerabilities 112 in the set of container images 122a. In these examples, the processor 104 may store the identified vulnerabilities 112 (or the identifiers of the vulnerabilities 112) in the data store 108.

The processor 104 may execute the instructions 202 to identify, from a set of reference vulnerabilities 114, which of the reference vulnerabilities 114 the identified vulnerabilities 112 match. According to examples, each of the reference vulnerabilities 114 may be assigned with corresponding identifiers, in which the identifiers of the reference vulnerabilities 114 may follow the same naming protocol as the vulnerabilities 112 identified in the set of container images 122a. In these examples, the processor 104 may compare the identifiers of the identified vulnerabilities 112 against identifiers of the reference vulnerabilities 114 to identify the reference vulnerabilities 114 to which the identified vulnerabilities match. That is, the identifiers of the reference vulnerabilities 114 may have been stored in the data store 108 or the identifiers of the reference vulnerabilities 114 may be stored in a remote data store, which the processor 104 may access.

As discussed in greater detail herein, each of the reference vulnerabilities 114 may be assigned corresponding mitigation priority values 116. The mitigation priority values 116 may correspond to priority levels at which the reference vulnerabilities 114 were mitigated. Thus, for instance, those reference vulnerabilities 114 that were mitigated sooner from the time when the reference vulnerabilities 114 were detected, may have been assigned higher mitigation priority values 116 than those reference vulnerabilities 114 that were mitigated later from the time when the reference vulnerabilities 114 were detected.

In some examples, the lengths of time between when the reference vulnerabilities 114 were detected and when they were mitigated, e.g., time to fix the vulnerabilities, may be average lengths of time. That is, the processor 104 may determine that an organization (or multiple organizations) took different lengths of time to mitigate a reference vulnerability 114 and may determine the mitigation priority value 116 for the reference vulnerability 114 to be an average of the different lengths of time. In other examples, the processor 104 may determine the mitigation priority value 116 for the reference vulnerability 114 to be an average of different mitigation priority values 116 for the reference vulnerability 114. The processor 104 may determine mitigation priority values 116 for the remaining reference vulnerabilities 114 in similar manners.

In some examples, the mitigation priority values 116 may directly correspond to the lengths of time between when the reference vulnerabilities 114 were detected and when they were mitigated. That is, the mitigation priority values 116 may be directly proportional to the length of time, e.g., each hour in the length of time may be equal to a value certain value. In some examples, the lengths of time may be assigned a corresponding one of a certain number of values, e.g., the lengths of time may be scaled to the certain number of values, for instance, in a scale between 1 to 10, between 1 to 100, or the like. By way of example, a first range of time lengths may correspond to a first mitigation priority value, a second range of time lengths may correspond to a second mitigation priority value, etc.

According to examples, the identifiers of the reference vulnerabilities 114 and the mitigation priority values 116 of the reference vulnerabilities 114 may be stored in a database, e.g., in a look up table. For instance, the identifiers of the reference vulnerabilities 114 may be provided in a first column and the mitigation priority values 116 of the reference vulnerabilities 114 may be provided in a second column.

The processor 104 may execute the instructions 204 to determine mitigation priority values 118 of the identified vulnerabilities 112 based on the migration priority values 116 assigned to the reference vulnerabilities to which the identified vulnerabilities 112 match. That is, the processor 104 may determine the mitigation priority values 118 of the identified vulnerabilities 112 to be equivalent to the mitigation priority values 116 of the reference vulnerabilities 114 to which the identified vulnerabilities 112 match.

The processor 104 may execute the instructions 206 to output the determined mitigation priority values 118 of the identified vulnerabilities 112. The processor 104 may output the determined mitigation priority values 118 to the organization 140 that owns or manages the set of container images 122a including the identified vulnerabilities 112, e.g., to a member of the organization 140. The processor 104 may also output the identified vulnerabilities 112 along with the mitigation priority values 118. For instance, the processor 104 may output a table that includes the identified vulnerabilities 112 in first column and the mitigation priority values 118 in a second column. The processor 104 may also output the identified vulnerabilities 112 and their corresponding mitigation priority values 118 through any suitable communication mechanism, such as a web-based application, an email, and/or the like.

With reference now to FIG. 3, the memory 106 may have stored thereon machine-readable instructions 300-306 that the processor 104 may execute. According to examples, the processor 104 may execute the instructions 300-306 prior to or in conjunction with the instructions 200-206 discussed above with respect to FIG. 2. In other examples, the processor 104 may execute the instructions 300-306 as a completely separate set of instructions from the instructions 200-206.

As shown, the processor 104 may execute the instructions 300 to access identifications of reference vulnerabilities 114 in a plurality of container images 122a-122n. The plurality of container images 122a-122n may also be termed reference container images 122a-122n as they are used to identify the reference vulnerabilities 114. In addition, the reference vulnerabilities 114 are termed “reference” because they are previously identified vulnerabilities that may be used as references for vulnerabilities 112 identified in sets of container images to be analyzed.

In some examples, the processor 104 may access identifiers of reference vulnerabilities 114 in a plurality of container images 122a-122n. As discussed herein, a container image scanning tool may determine the existence of the reference vulnerabilities 114 in the container images 122a-122n and the identifiers assigned to the determined reference vulnerabilities 114. The processor 104 may obtain the identifiers of the reference vulnerabilities 114 from the results of scans performed by the container image scanning tool on the container images 122a-122n. In addition, the processor 104 may access identifications of the vulnerabilities identified in the container images 122a-122n stored in a plurality of registries 120a-120n over a period of time, e.g., during a learning phase. In some examples, the processor 104 may execute the container image scanning tools to identify the vulnerabilities in the container images 122a-122n. In other examples, the processor 104 may collect information regarding the vulnerabilities identified by members of organizations that may own and/or manage the container images 122a-122n.

The processor 104 may execute the instructions 302 to determine respective lengths of time between when the reference vulnerabilities 114 were identified and when the reference vulnerabilities 114 were mitigated. Particularly, for instance, the processor 104 may determine and store when the reference vulnerabilities 114 were identified. The processor 104 may make this determination based on time stamps of when the reference vulnerabilities 114 were identified, time stamps of when the processor 104 was informed of the reference vulnerabilities 114, etc. In addition, the processor 104 may store the times at which the reference vulnerabilities were identified.

The processor 104 may also determine and store when the reference vulnerabilities 114 were mitigated. That is, for instance, the processor 104 may determine when the container images 122a-122n including the reference vulnerabilities 114 were updated with patches and/or when newer versions of those container images 122a-122n were stored in the registries 120a-120n. The processor 104 may determine when the reference vulnerabilities 114 in the container images 122a-122n were mitigated as being the times and/or dates on which those container images 122a-122n were updated with patches or newer versions. The processor 104 may determine the respective lengths of time between when the reference vulnerabilities 114 were identified and when they were mitigated by determining the differences in the determined times between when they were identified and when they were mitigated.

The processor 104 may execute the instructions 304 to assign mitigation priority values 116 to the reference vulnerabilities 114 based on the determined respective lengths of time between when the reference vulnerabilities 114 were identified and when they were mitigated. As discussed herein, the processor 104 may assign the mitigation priority values 116 to be directly proportional to the lengths of time at which the reference vulnerabilities 114 were fixed. Alternatively, the processor 104 may assign the mitigation priority values 116 according to a scaled distribution of lengths of time at which the reference vulnerabilities 114 were fixed.

The processor 104 may execute the instructions 306 to store the assigned mitigation priority values 116 for the reference vulnerabilities 114, for instance, in the data store 108. Particularly, the processor 104 may store identifiers of the reference vulnerabilities 114 along with the corresponding mitigation priority values 116 assigned to the reference vulnerabilities 114. In some examples, the processor 104 may store the identifiers of the reference vulnerabilities 114 and the corresponding mitigation priority values 116 in a look up table that the processor 104 may later reference. In any regard, the processor 104 may create a set of reference vulnerabilities 114 and their corresponding mitigation priority values 116, which the processor 104 may use in determining mitigation priority values 118 of vulnerabilities 112 identified in a set of container images 122a.

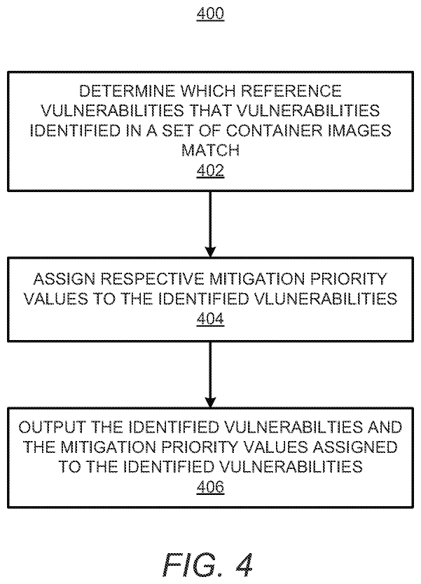

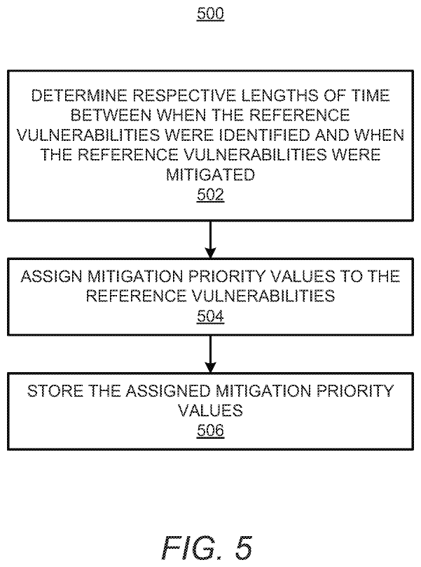

Although the instructions 200-206 and 300-306 are described herein as being stored on the memory 106 and may thus include a set of machine-readable instructions, the apparatus 102 may include hardware logic blocks that may perform functions similar to the instructions 200-206 and 300-306. For instance, the processor 104 may include hardware components that may execute the instructions 200-206 and 300-306. In other examples, the apparatus 102 may include a combination of instructions and hardware logic blocks to implement or execute functions corresponding to the instructions 200-206 and 300-306. In any of these examples, the processor 104 may implement the hardware logic blocks and/or execute the instructions 200-206 and 300-306. As discussed herein, the apparatus 102 may include additional instructions and/or hardware logic blocks such that the processor 104 may execute operations in addition to or in place of those discussed above with respect to FIGS. 2 and/or 3. Various manners in which the processor 104 of the apparatus 102 may operate are discussed in greater detail with respect to the methods 400 and 500 depicted in FIGS. 4 and 5. Particularly, FIG. 4 depicts a flow diagram of a method 400 for assigning mitigation priority values 118 to a plurality of vulnerabilities 112 identified in a set of container images 122a and outputting the assigned mitigation priority values 118, in accordance with an embodiment of the present disclosure. FIG. 5 depicts a flow diagram of a method 500 for assigning mitigation priority values 116 to reference vulnerabilities 114, in which the mitigation priority values 116 assigned to the reference vulnerabilities 114 are to be used to determine the mitigation priority values 118 assigned to the identified vulnerabilities 112 in the set of container images 122a, in accordance with an embodiment of the present disclosure. It should be understood that the methods 400 and 500 may include additional operations and that some of the operations described therein may be removed and/or modified without departing from the scopes of the methods 400 and 500. The descriptions of the methods 400 and 500 are made with reference to the features depicted in FIGS. 1-3 for purposes of illustration.

With reference first to FIG. 4, at block 402, the processor 104 may determine which reference vulnerabilities 114 that a plurality of vulnerabilities 112 identified in a set of container images 122a match. As discussed herein, each of the reference vulnerabilities 114 may be assigned one of a plurality of mitigation priority values 116. In addition, the mitigation priority values 116 may correspond to respective lengths of time between when the reference vulnerabilities 114 were identified and when the reference vulnerabilities 114 were mitigated. As also discussed herein, the processor 104 may access identifiers of the identified vulnerabilities 112 and may compare the identifiers of the identified vulnerabilities 112 against identifiers of the reference vulnerabilities 114 to identify the reference vulnerabilities 114 to which the identified vulnerabilities 112 match.

In some examples, the processor 104 may identify the vulnerabilities 112 in the set of container images 122a through performance of an image scanning operation on the container images 122a. In addition or in other examples, the processor 104 may receive the identified vulnerabilities 112 from an outside entity. The outside entity may be outside of the apparatus 102 containing the processor 104 and may be, for instance, a member of an organization 140 that may own and/or manage the set of container images 122a. In these examples, the outside entity may perform the image scanning operation on the container images 122a.

At block 404, the processor 104 may assign respective mitigation priority values 118 to the identified vulnerabilities 112 in the set of container images 122a that are equal to the mitigation priority values 116 assigned to the reference vulnerabilities 114 determined to match the identified vulnerabilities 112. In addition, the processor 104 may store the assignments of the identified vulnerabilities 112 and the assigned mitigation priority values 118, for instance, in the data store 108. By way of example, the processor 104 may store identifiers of the identified vulnerabilities 112 along with their assigned mitigation priority values 118 in a look up table.

At block 406, the processor 104 may output the identified vulnerabilities 112 and the mitigation priority values 118 assigned to the identified vulnerabilities 112. In some examples, the set of container images 112a are stored in a registry 120a owned by an organization 140. In these examples, the processor 104 may output the identified vulnerabilities 112 and the mitigation priority values 118 assigned to the identified vulnerabilities 112 to a member of the organization 140.

Turning now to FIG. 5, at block 502, the processor 104 may determine respective lengths of time between when the reference vulnerabilities 114 were identified and when the reference vulnerabilities 114 were mitigated. The processor 104 may determine this information in any of the manners discussed herein.

At block 504, the processor 104 may assign the mitigation priority values 116 to the reference vulnerabilities 114 in the plurality of container images 122a-122n based on the determined respective lengths of time corresponding to the reference vulnerabilities. For instance, the processor 104 may assign the reference vulnerabilities 114 that were mitigated relatively faster from when they were identified higher mitigation priority values than other reference vulnerabilities 114. By way of example, the processor 104 may assign the mitigation priority values 116 as values between 1 and 10, in which the numeral 10 may correspond to the highest mitigation priority value and the numeral 1 may correspond to the lowest mitigation priority value. In other examples, the mitigation priority values 116 may directly correspond to the lengths of time between when the reference vulnerabilities 114 were identified and when they were mitigated.

At block 506, the processor 104 may store the assigned mitigation priority values 116 of the reference vulnerabilities 114 and the reference vulnerabilities to which the mitigation priority values 116 have been assigned. The processor 104 may store the identifiers of the reference vulnerabilities 114 and the mitigation priority values 116 in the data store 108. By way of example, the processor 104 may store the identifiers of the reference vulnerabilities 114 and the mitigation priority values 116 in a look up table and may store the look up table in the data store 108.

Some or all of the operations set forth in the methods 400 and 500 may be included as utilities, programs, or subprograms, in any desired computer accessible medium. In addition, the methods 400 and 500 may be embodied by computer programs, which may exist in a variety of forms both active and inactive.

For example, they may exist as machine-readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

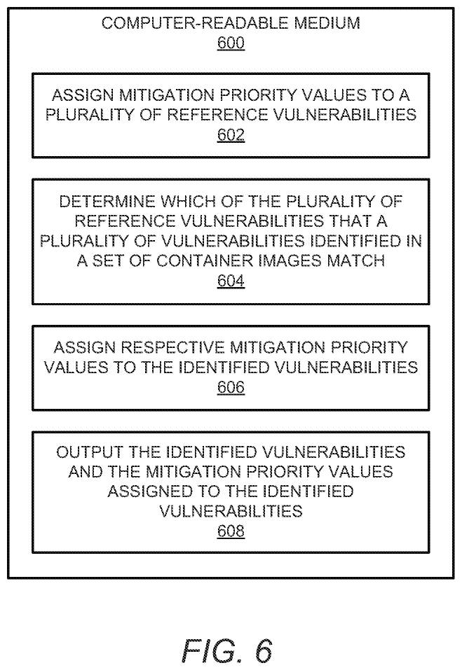

Turning now to FIG. 6, there is shown a block diagram of a computer-readable medium 600 that may have stored thereon computer-readable instructions for assigning respective mitigation priority values 118 to identified vulnerabilities 112 in a set of container images 122a based on mitigation priority values 116 of reference vulnerabilities 114, in accordance with an embodiment of the present disclosure. It should be understood that the computer-readable medium 600 depicted in FIG. 6 may include additional instructions and that some of the instructions described herein may be removed and/or modified without departing from the scope of the computer-readable medium 600 disclosed herein. The computer-readable medium 600 may be a non-transitory computer-readable medium, in which the term “non-transitory” does not encompass transitory propagating signals.

The computer-readable medium 600 may have stored thereon computer-readable instructions 602-608 that a processor, such as the processor 104 of the apparatus 102 depicted in FIGS. 1-3, may execute. The computer-readable medium 600 may be an electronic, magnetic, optical, or other physical storage device that contains or stores executable instructions. The computer-readable medium 600 may be, for example, Random Access memory (RAM), an Electrically Erasable Programmable Read-Only Memory (EEPROM), a storage device, an optical disc, and the like.

The processor may fetch, decode, and execute the instructions 602 to assign mitigation priority values 118 to a plurality of reference vulnerabilities 114 based on respective lengths of time between when the reference vulnerabilities 114 were identified and when the reference vulnerabilities 114 were mitigated. Particularly, for instance, the processor may execute instructions to cause the processor to determine the respective lengths of time between when the reference vulnerabilities 114 were identified and when the reference vulnerabilities 114 were mitigated. The processor may determine when the reference vulnerabilities 114 were mitigated based on when versions of the container images 122a-122n containing the reference vulnerabilities 114 were updated and/or patched.

The processor may also execute instructions to cause the processor to assign the mitigation priority values 118 to the reference vulnerabilities 114 in the plurality of container images 122a-122n based on the determined respective lengths of time corresponding to the reference vulnerabilities 114. The processor may further store the assigned mitigation priority values 116 of the reference vulnerabilities 114 and the reference vulnerabilities 114 to which the mitigation priority values 116 have been assigned.

The processor may fetch, decode, and execute the instructions 604 to determine which of the plurality of reference vulnerabilities 114 that a plurality of vulnerabilities 112 identified in a set of container images 122a match. For instance, the processor may access identifiers of the identified vulnerabilities 112 and may compare the identifiers of the identified vulnerabilities 112 against identifiers of the reference vulnerabilities 114 to identify the reference vulnerabilities 114 to which the identified vulnerabilities 112 match.

The processor may fetch, decode, and execute the instructions 606 to assign respective mitigation priority values 118 to the identified vulnerabilities 112 in the set of container images 122a that are equal to the mitigation priority values 116 assigned to the reference vulnerabilities 114 determined to match the identified vulnerabilities 112. In addition, the processor may fetch, decode, and execute the instructions 608 to output the identified vulnerabilities 112 and the mitigation priority values 118 assigned to the identified vulnerabilities 112.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. An apparatus comprising:
a processor; and
a memory on which is stored machine-readable instructions that when executed by the processor, cause the processor to:
access vulnerabilities identified in a set of container images;
identify, from a set of reference vulnerabilities, which reference vulnerabilities the identified vulnerabilities match, wherein each of the reference vulnerabilities is assigned one of a plurality of mitigation priority values;
determine mitigation priority values of the identified vulnerabilities based on the mitigation priority values assigned to the reference vulnerabilities to which the identified vulnerabilities match; and
output the determined mitigation priority values of the identified vulnerabilities.

2. The apparatus of claim 1, wherein the instructions cause the processor to:
access identifiers of the identified vulnerabilities; and
compare the identifiers of the identified vulnerabilities against identifiers of the reference vulnerabilities to identify the reference vulnerabilities to which the identified vulnerabilities match.

3. The apparatus of claim 1, wherein the mitigation priority values correspond to respective average lengths of time between when the reference vulnerabilities were identified and when the reference vulnerabilities were mitigated.

4. The apparatus of claim 1, wherein the instructions cause the processor to:
access identifications of the reference vulnerabilities in a plurality of container images;
determine respective lengths of time between when the reference vulnerabilities were identified and when the reference vulnerabilities were mitigated;
assign the mitigation priority values to the reference vulnerabilities in the plurality of container images based on the determined respective lengths of time corresponding to the reference vulnerabilities; and
store the assigned mitigation priority values of the reference vulnerabilities and the mitigation priority values assigned to the reference vulnerabilities.

5. The apparatus of claim 4, wherein the instructions cause the processor to:
determine when the reference vulnerabilities were mitigated based on when versions of the container images containing the reference vulnerabilities were updated and/or patched.

6. The apparatus of claim 4, wherein the instructions cause the processor to:
assign higher mitigation priority values to the reference vulnerabilities that were mitigated within shorter lengths of time between when the reference vulnerabilities were identified and when the reference vulnerabilities were mitigated.

7. The apparatus of claim 4, wherein the instructions cause the processor to:
store the assigned mitigation priority values of the reference vulnerabilities and the mitigation priority values assigned to the reference vulnerabilities in a look up table.

8. The apparatus of claim 1, wherein the set of container images are stored in a registry owned by an organization, and wherein the instructions cause the processor to:
output the determined mitigation priority values of the identified vulnerabilities to a member of the organization.

9. The apparatus of claim 1, wherein the instructions cause the processor to:
perform an image scanning operation on the container images included in the set of container images to identify the vulnerabilities; and/or
receive the identified vulnerabilities from an entity outside of the apparatus.

10. A method comprising:
determining, by a processor, which reference vulnerabilities that a plurality of vulnerabilities identified in a set of container images match, wherein each of the reference vulnerabilities is assigned one of a plurality of mitigation priority values, and wherein the mitigation priority values correspond to respective lengths of time between when the reference vulnerabilities were identified and when the reference vulnerabilities were mitigated;
assigning, by the processor, respective mitigation priority values to the identified vulnerabilities in the set of container images that are equal to the mitigation priority values assigned to the reference vulnerabilities determined to match the identified vulnerabilities; and
outputting, by the processor, the identified vulnerabilities and the mitigation priority values assigned to the identified vulnerabilities.

11. The method of claim 10, further comprising:
accessing identifiers of the identified vulnerabilities; and
comparing the identifiers of the identified vulnerabilities against identifiers of the reference vulnerabilities to identify the reference vulnerabilities to which the identified vulnerabilities match.

12. The method of claim 10, further comprising:
determining respective lengths of time between when the reference vulnerabilities were identified and when the reference vulnerabilities were mitigated;
assigning the mitigation priority values to the reference vulnerabilities in a plurality of container images based on the determined respective lengths of time corresponding to the reference vulnerabilities; and
storing the assigned mitigation priority values of the reference vulnerabilities and the mitigation priority values assigned to the reference vulnerabilities.

13. The method of claim 12, further comprising:
determining when the reference vulnerabilities were mitigated based on when versions of the container images containing the reference vulnerabilities were updated and/or patched.

14. The method of claim 12, further comprising:
assigning higher mitigation priority values to the reference vulnerabilities that were mitigated within shorter lengths of time between when the reference vulnerabilities were identified and when the reference vulnerabilities were mitigated.

15. The method of claim 10, wherein the set of container images are stored in a registry owned by an organization, the method further comprising:
outputting the identified vulnerabilities and the mitigation priority values assigned to the identified vulnerabilities to a member of the organization.

16. The method of claim 10, further comprising:
performing an image scanning operation on the container images included in the set of container images to identify the vulnerabilities; and/or
receiving the identified vulnerabilities from an outside entity.

17. A computer-readable medium on which is stored computer-readable instructions that when executed by a processor, cause the processor to:
assign mitigation priority values to a plurality of reference vulnerabilities based on respective lengths of time between when the reference vulnerabilities were identified and when the reference vulnerabilities were mitigated;
determine which of the plurality of reference vulnerabilities that a plurality of vulnerabilities identified in a set of container images match;
assign respective mitigation priority values to the identified vulnerabilities in the set of container images that are equal to the mitigation priority values assigned to the reference vulnerabilities determined to match the identified vulnerabilities; and
output the identified vulnerabilities and the mitigation priority values assigned to the identified vulnerabilities.

18. The computer-readable medium of claim 17, wherein the instructions further cause the processor to:
access identifiers of the identified vulnerabilities; and
compare the identifiers of the identified vulnerabilities against identifiers of the reference vulnerabilities to identify the reference vulnerabilities to which the identified vulnerabilities match.

19. The computer-readable medium of claim 17, wherein the instructions further cause the processor to:
determine the respective lengths of time between when the reference vulnerabilities were identified and when the reference vulnerabilities were mitigated;
assign the mitigation priority values to the reference vulnerabilities in a plurality of container images based on the determined respective lengths of time corresponding to the reference vulnerabilities; and
store the assigned mitigation priority values of the reference vulnerabilities and the reference vulnerabilities to which the mitigation priority values have been assigned.

20. The computer-readable medium of claim 19, wherein the instructions further cause the processor to:
determine when the reference vulnerabilities were mitigated based on when versions of the container images containing the reference vulnerabilities were updated and/or patched.
